(19) United States
(12) Patent Application Publication
(10) Pub. No.: US 2008/0058472 A1
(43) Pub. Date: Mar. 6, 2008

(54) THERMOPLASTIC ELASTOMER COMPOSITION WITH AN IMPROVED RUBBER PELLETIZATION PROCESS

(75) Inventors: Yoshihiro Soeda, Hiratsuka-shi (JP); Andy Haishung Tsou, Houston, TX (US); Joyce Foshee Caraway, Crosby, TX (US)

Correspondence Address: CONNOLLY BOVE LODGE & HUTZ LLP, 1875 EYE STREET, N.W., SUITE 1100, WASHINGTON, DC, 20036, US

(73) Assignees: The Yokohama Rubber Co., Ltd., Tokyo (JP); ExxonMobil Chemical Patents Inc., Houston, TX (US)

(21) Appl. No.: 11/932,651

(22) Filed: Oct. 31, 2007

Related U.S. Application Data
(62) Division of application No. 10/548,063, filed on Jun. 6, 2006.

(51) Int. Cl. C08L 27/24

(52) U.S. Cl. 525/190

(57) ABSTRACT

A thermoplastic elastomer composition having improved durability, heat resistant and flexibility comprising a dynamically vulcanized blend of (A) a halogenated isobutylene elastomer, (B) polyamide and (C) an antioxidant having a melating temperature more than 70° C. and less than 200° C., wherein the elastomer (A) is dispersed as a domain in a continuous phase of the polyamide (B) and the dynamically vulcanized blend of the components (A) and (B) is dynamically vulcanized in the presence of the antioxidant (C) as an anti-blocking agent.

### TECHNICAL FIELD

The present invention provides an improved thermoplastic elastomer composition having excellent durability, heat resistance and flexibility, while possessing superior air impermeability. In particular, the present invention relates to a thermoplastic elastomer composition using an antioxidant as an anti-blocking agent, where the antioxidant used has a melting temperature more than 70° C. and less than 200° C.

### BACKGROUND ART

EP722850B1 disclosed a low-permeability thermoplastic elastomer composition that is superior as a gas-barrier layer in pneumatic tires. This thermoplastic composition comprises a low-permeability thermoplastic matrix, such as polyamides or blends of polyamides, in which a low-permeability rubber such as brominated poly(isobutylene-co-p-methylstyrene) (i.e., BIMS) is dispersed. Subsequently, in both EP857761A1 and EP969039A1, viscosity ratio between the thermoplastic matrix and the rubber dispersion was specified as a function of the volume fraction ratio and independently to be close to one in order to achieve phase continuity in thermoplastic and fine rubber dispersions, respectively. Criticality of smaller rubber dispersions was recognized in EP969039A1 in these thermoplastic elastomers for delivering acceptable durability especially for their usage as innerliners in pneumatic tires.

### SUMMARY OF INVENTION

The object of the present invention is to provide a thermoplastic elastomer composition having an improved durability, heat resistance and flexibility, while possessing superior air impermeability.

In accordance with the present invention, there is provided a thermoplastic elastomer composition having improved durability, heat resistant and flexibility comprising a dynamically vulcanized blend of (A) a halogenated isobutylene elastomer, (B) polyamide and (C) an antioxidant having a melting temperature more than 70° C. and less than 200° C., wherein the elastomer (A) is dispersed as a domain in a continuous phase of the component (B) and the components (A) and (B) are dynamically vulcanized in the presence of the antioxidant as an anti-blocking agent.

### DISCLOSURE OF INVENTION

In this specification and in the claims which follow, the singular forms “a”, “an” and “the” include plural referents unless the context clearly dictates otherwise.

The present invention relates to a thermoplastic elastomer composition, more particularly relates to a thermoplastic elastomer composition excellent in durability and in impermeability. This thermoplastic elastomer contains rubber particles with improved rubber pelletization process. More specifically, rubber compounds are pelletized with the usage of antioxidants as the anti-blocking agent where antioxidants used having a melting temperature more than 70° C. and less than 200° C.

Most specifically, the rubber compounds and polyamides are dynamically vulcanized in the presence of an antioxidant such as triphosphite antioxidants, hindered phenol antioxidants either alone or in the combination with other antioxidant(s), at preferably 5 phr (i.e., parts by weight per hundred rubber) or less, more preferably 4 phr or less, still more preferably 3 phr or less, further more preferably 2 phr or less, most preferably, at 1 phr or less.

Typical examples of the triphosphite antioxidants are tris(di-tertiary butylphenyl)phosphite, tris-nonylphenylphosphite; and typical examples of the hindered phenol antioxidants are 4,4′-butylidene bis-(3-methyl-6-tert-butylphenol), 2-4-bis[(octylthio)methyl]-o-cresol.

The thermoplastic elastomer composition is a blend of a halogenated isobutylene elastomer and a polyamide, which is subjected to dynamic vulcanization.

The term “dynamic vulcanization” is used herein to connote a vulcanization process in which the engineering resin and a vulcanizable elastomer are vulcanized under conditions of high shear. As a result, the vulcanizable elastomer is simultaneously crosslinked and dispersed as fine particles of a “micro gel” within the engineering resin matrix.

Dynamic vulcanization is effected by mixing the ingredients at a temperature which is at or above the curing temperature of the elastomer in equipment such as roll mills, Banbury® mixers, continuous mixers, kneaders or mixing extruders, e.g., twin screw extruders. The unique characteristic of the dynamically cured compositions is that, notwithstanding the fact that the elastomer component may be fully cured, the compositions can be processed and reprocessed by conventional thermoplastic resin processing techniques such as extrusion, injection molding, compression molding, etc. Scrap or flashing can be salvaged and reprocessed.

In a preferred embodiment the halogenated isobutylene elastomer component include copolymers of isobutylene and para-alkylstyrene, such as described in European Patent Application 0 344 021. The copolymers preferably have a substantially homogeneous compositional distribution. Preferred alkyl groups for the para-alkyl styrene moiety include alkyl groups having from 1 to 5 carbon atoms, primary haloalkyl, secondary haloalkyl having from 1 to 5 carbon atoms and mixtures thereof. A preferred copolymer comprises isobutylene and para-methylstyrene.

Suitable halogenated isobutylene elastomer components include copolymers (such as brominated isobutylene-paramethylstyrene copolymers) having a number average molecular weight Mn of at least about 25,000, preferably at least about 50,000, preferably at least about 75,000, preferably at least about 100,000, preferably at least about 150,000. The copolymers may also have a ratio of weight average molecular weight (Mw) to number average molecular weight (Mn), i.e., Mw/Mn of less than about 6, preferably less than about 4, more preferably less than about 2.5, most preferably less than about 2.0. In another embodiment, suitable halogenated isobutylene elastomer components include copolymers (such as brominated isobutylene-paramethylstyrene copolymers) having a Mooney viscosity (1+4) at 125° C. (as measured by ASTM D 1646-99) of 25 or more, preferably 30 or more, more preferably 40 or more.

Preferred brominated copolymers of isobutylene and para-methylstyrene include those having 5 to 12 weight % para-methylstyrene, 0.3 to 1.8 mol % brominated para-methylstyrene, and a Mooney viscosity of 30 to 65 (1+4) at 125° C. (as measured by ASTM D 1646-99).

The halogenated isobutylene elastomer component (A) according to the present invention can be prepared from isobutylene and about 0.5 to 25% by weight, preferably about 2 to 20% by weight, based upon the total amount of the comonomers, of p-alkylstyrene, preferably p-methylstyrene, followed by the halogenation. The content of the halogen (e.g., Br and/or Cl, preferably Br) is preferably less than about 10% by weight, more preferably about 0.1 to about 7% by weight, based upon the total amount of the copolymer.

The copolymerization can be carried out in a known manner as described in, for example, European Patent Publication No. EP-34402/A published Nov. 29, 1989 and the halogenation can be carried out in a known method as described in, for example, U.S. Pat. No. 4,548,995.

The halogenated isobutylene elastomer preferably has the number-average molecular weight (Mn) of at least about 25,000, more preferably at least about 100,000 and a ratio of the weight-average molecular weight Mw to the number-average molecular weight (Mn), i.e., Mw/Mn of preferably less than about 10, more preferably less than about 8.

The polyamides usable in the present invention are thermoplastic polyamides (nylons) comprise crystalline or resinous, high molecular weight solid polymers including copolymers and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines. Both fiber-forming and molding grade nylons are suitable. Examples of such polyamides are polycaprolactam (Nylon 6), polylauryllactam (Nylon 12), polyhexamethyleneadipamide (Nylon 66), polyhexamethyleneazelamide (Nylon 69), polyhexamethylenesebacamide (Nylon 610), polyhexamethyleneisophthalamide (Nylon 6 IP) and the condensation product of 11-amino-undecanoic acid (Nylon 11). Nylon 6 (N6), Nylon 11 (N11), Nylon 12 (N12), a Nylon 6/66 copolymer (N6/66), Nylon 610 (N610), Nylon 46, Nylon MXD6, Nylon 69 and Nylon 612 (N612) may also be used. The copolymers thereof any blends thereof may also be used. Additional examples of satisfactory polyamides (especially those having a softening point below 275° C.) are described in Kirk-Othmer, Encyclopedia of Chemical Technology, v. 10, page 919, and Encyclopedia of Polymer Science and Technology, Vol. 10, pages 392-414. Commercially available thermoplastic polyamides may be advantageously used in the practice of this invention, with linear crystalline polyamides having a softening point or melting point between 160° C.-230° C. being preferred.

The amounts of the elastomer (A) and the polyamide (B) usable in the present invention is preferably 95 to 25 parts by weight and 5 to 75 parts by weight, more preferably 90 to 25 parts by weight and 10 to 75 parts by weight, respectively, provided that the total amount of the components (A) and (B) is 100 parts by weight.

The method for producing the thermoplastic elastomer composition in the present invention consists of melting and kneading the halogenated isobutylene elastomer (A), the polyamide (B) and the antioxidant (C) by a biaxial kneader/extruder etc. to disperse the elastomer (A) in the polyamide (B) forming the continuous phase. When vulcanizing the elastomer (A), a vulcanization agent is added, while kneading, and the elastomer component is dynamically vulcanized. Further, the various compounding agents (except vulcanization agent) for the elastomer and the polyamide may be added during the above kneading, but preferably are mixed in advance before the kneading. The kneader used for kneading the polyamide and the elastomer is not particularly limited. Examples thereof are a screw extruder, kneader, banbury mixer, biaxial kneader/extruder, etc. Among these, it is preferable to use a biaxial kneader/extruder for the kneading of the thermoplastic resin and the elastomer and the dynamic vulcanization of the elastomer. Further, two or more types of kneaders may be used for successive kneading. As the conditions for the melting and kneading, the temperature should be at least the temperature where the polyamide melts. Further, the shear rate at the time of kneading is preferably 500 to 7500 sec⁻¹. The time for the overall kneading is from 30 seconds to 10 minutes. Further, when adding a vulcanization agent, the vulcanization time after addition is preferably 15 seconds to 5 minutes. The elastomer composition produced by the above method is then extruded or calendered into a film. The method of forming the film may be a usual method of forming a film from a thermoplastic resin or thermoplastic elastomer.

The elastomer composition according to the present invention may contain, in addition to the above-mentioned essential ingredients, a vulcanization or cross-linking agent, a vulcanization or cross-linking accelerator, various types of oils, an antiaging agent, reinforcing agent, plasticizer, softening agent, or other various additives generally mixed into general rubbers. The compounds are mixed and vulcanized by general methods to make the composition which may then be used for vulcanization or cross-linking. The amounts of these additives added may be made the amounts generally added in the past so long as they do not run counter to the object of the present invention.

### EXAMPLES

The present invention will now be further illustrated by, but is by no means limited to, the following Examples.

1. Resin Component
Nylon (Nylon 6/66): Ube Nylon (Ube Kousan)
Additives: antioxidant: Irganox 1098, Tinuvin 622LD, and CuI

2. Elastomer Component
BIMS: Brominated copolymer of isobutylene and para-methylstyrene sold under the tradename EXXPRO 89-4 by ExxonMobil Chemical Company having a mooney viscosity of about 45, approximately 5 weight % para-methylstyrene and about 0.75 mol % bromine
ZnO: Zinc oxide curative
St-acid: Stearic acid curative
ZnSt: Zinc sterate curative
DM16D: Tertiary amine: ARMEEN DM16D (AKZO NOBEL)

3. Granulator
Talc: NIPPON TALC K.K.
IRGAFOS 168: antioxidant available from Ciba
Curing Agent: ZnO, St-acid and ZnSt (see Table 1)
   The test methods used for evaluation of the Examples and Comparative Examples were as follows:
   A) Durability (Cold Temperature Fatigue Cycles)
   Film and a carcass compound were laminated together with an adhesive and cured at 190° C. for 10 min. A JIS No. 2 dumbbell shape was then punched out and used for durability test at −20° C. at 6.67 Hz and 40% strain.
   B) Tensile Mechanical Properties
   All tensile tests are based on JIS K6251 “Tensile Test Method of Vulcanized Rubber”.

For Examples 1, 2, 4 and 5, the ingredients (parts by weight), other than Nylon and additives, shown in Table 1 were kneaded in a banbury mixer (discharge temp.=120° C.) for 2 minutes, followed by pelletizing the resultant composition in a conventional manner with coating with the granulator. For Example 3 (Comparative), Exxpro 89.4 was kneaded in a bambury mixer, followed by pelletizing in a conventional manner with coating with the granulator. Thereafter, the resultant pellets and Nylon and the additives shown in Table 1 were dynamically vulcanized by a biaxial extruder at 230° C. and a shear rate of 1000 S⁻¹.

TABLE 1
RECIPE

(parts by weight)

| | Example | | | | |
|---|---|---|---|---|---|
| Ingredient | 1 | 2 | 3*¹ | 4 | 5 |
| Exxpro 89-4 | 100 | 100 | 100 | 100 | 100 |
| ZnO | 0.15 | 0.15 | 0.15 | 0.15 | 0.15 |
| St-acid | 0.6 | 0.6 | 0.6 | 0.6 | 0.6 |
| ZnSt | 0.3 | 0.3 | 0.3 | 0.3 | 0.3 |
| DM16D | — | — | — | 1.0 | 1.0 |
| Granulator | Talc | IRGAFOS | Cure | Tale | IRGAFOS |
| | | 168 | agent | | 168 |
| Nylon | 98 | 98 | 98 | 98 | 98 |
| Additives | 1.23 | 1.23 | 1.23 | 1.23 | 1.23 |
| Total | 200.28 | 200.28 | 199.23 | 201.28 | 201.28 |

*¹Comparative Example

TABLE 2
Mechanical properties

| | Example | | |
|---|---|---|---|
| | 1 | 2 | 3 |
| TB at −20° C. (MPa) | 44.2 | 43.6 | 38.1 |
| EB at −20° C. (%) | 320 | 320 | 290 |
| Durability × 10⁶ times | 1.0-1.5 | 1.0-1.5 | 0.1 |

The films having the composition listed in Table 1 were blown using same blow die. Mechanical properties are listed in Table 2.

The film using the antioxidant as a granulator has good elongation compare to cure agent as a granulator.

Also, the film using antioxidant as a granulator has same excellent low temperature durability and low temperature stability as the film using talc.

TABLE 3
Mechanical properties

Example

| | 4 | 5 |
|---|---|---|
| TB at −20° C. (MPa) | 49.0 | 45.6 |
| EB at −20° C. (%) | 375 | 370 |
| Durability × 10⁶ times | 1.0 | 1.2 |

The films having the composition listed in Table 1 were blown using the same blow die. The mechanical properties thereof are listed in Table 3. The mechanical properties of the thermoplastic elastomer containing the rubber particles with improved rubber pelletization process are good. The film has the same mechanical properties. The film using the antioxidant as a granulator has the same elongation as in the case of using talc as a granulator. Also, the film using antioxidant as a granulator has the same excellent low temperature durability.

What is claimed is:

1. A method for making a thermoplastic elastomer composition comprising:
(A) forming a mixture comprising a halogenated isobutylene elastomer and at least one curative therefore;
(B) producing pellets from the mixture formed in (A);
(C) coating the pellets produced in (B) with a granulated antioxidant having a melting temperature more than 70° C. and less than 200° C. in an amount sufficient to function as an antiblocking agent;
(D) providing a polyamide, and
(E) mixing the coated pellets (C) and the polyamide under dynamic vulcanization conditions to produce a thermoplastic elastomer composition wherein the elastomer is dispersed as a domain in a continuous phase of the polyamide.

2. The method of claimed in claim 1, wherein the amount of the halogenated isobutylene elastomer is 95 to 25 parts by weight and the amount of the polyamide is 5 to 75 parts by weight.

3. The method as claimed in claim 1, wherein the amount of the antioxidant is 5 parts by weight or less, based upon 100 parts by weight of the halogenated isobutylene elastomer.

4. The method as claimed in claim 1, wherein the halogenated isobutylene elastomer is brominated poly(isobutylene-co-p-methylstyrene).

5. The method as claimed in claim 1, wherein the polyamide is at least one member selected from the group consisting of Nylon 6, Nylon 66, Nylon 11, Nylon 12, Nylon 69, Nylon 610, Nylon 46, Nylon MXD6, Nylon 6/66, and the copolymers thereof, and the blends thereof.

6. The method as claimed in claim 1, wherein the antioxidant is at least one member selected from the group consisting of triphosphite antioxidants, either alone or in combination with other antioxidant(s).
